(19) United States
(12) Patent Application Publication
(10) Pub. No.: US 2011/0099494 A1
(43) Pub. Date: Apr. 28, 2011

(54) DYNAMIC GRAPHICAL USER INTERFACE LAYOUT

(75) Inventors: Xin Yan, Bellevue, WA (US); Joseph S. Binder, Seattle, WA (US)

(73) Assignee: Microsoft Corporation, Redmond, WA (US)

(21) Appl. No.: 12/603,590

(22) Filed: Oct. 22, 2009

(51) Int. Cl. G06F 3/048

(52) U.S. Cl. 715/765

(57) ABSTRACT

A system and method for laying out graphical user interface elements at a client device. A client device receives a set of containers, each container including program instructions and specifications. The program instructions of each container are executed to determine a size and position of each graphical user interface element. Each type of container has corresponding logic upon which sizing and positioning of graphical user interface elements is based. The client device may receive data metadata descriptive of the graphical user interface elements and application specifications. Sizing and positioning of the graphical user interface elements may be based on the data metadata and application specifications. A layout process may recursively descend a structure of containers to determine sizes and positions of each GUI element.

### BACKGROUND

The design and specification of a graphical user interface by a developer can be a complex task. Often, requirements of the graphical user interface (GUI) may change during the development process, or after it is complete. This may cause a developer to perform large portions of the design and specification process multiple times. Typically, an application is intended to execute in a variety of environments, including differing display properties. Developers may need to become familiar with the different environments to create a GUI that has a consistent appearance. Development of a GUI is subject to errors of not accounting for one or more environments. An example of this is a GUI that may be correct when a window is a normal size, but one or more of the GUI elements does not adjust properly when the window is maximized.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to dynamically layout graphical user interface (GUI) elements in a form at a client computing device. In one embodiment, a computing device receives a set of containers, each container having associated program instructions and specifications. The computing device may also receive metadata descriptive of controls to be included in the GUI form and a set of GUI settings. The client computing device may execute program instructions to determine a size or position of the GUI controls based on the metadata, the containers, and the display environment.

In one embodiment, the containers and the GUI elements form a hierarchical structure. A process may determine, for each container, a virtual size based on the GUI elements that are descendents of the container in the hierarchical structure. A process may determine, for each container, whether to include a scroll bar, based on an aggregate minimum size and an aggregate target size of the GUI elements that are descendents of the container in the hierarchical structure.

In one embodiment, a process may execute program instructions corresponding to a container to determine an ordering of the container relative to another container. The determination may be based on metadata associated with each container. A process may determine an indentation of GUI elements associated with the container based on a relationship between the GUI element and another GUI element associated with the other container.

In one embodiment, a tab container may be selectively employed based on a size of another container and its GUI elements. For example, a stack container may determine that its GUI elements do not fit well within it, and invoke one or more tab containers to display some or all of the stack container's GUI elements

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of an example environment in which embodiments may be practiced;

FIG. 2 is a block diagram illustrating an example embodiment of a layout system that may be employed to generate a graphical user interface;

FIG. 3 is a pictorial diagram of an example graphical user interface that may be generated in some embodiments;

FIG. 4 is a flow diagram illustrating an example embodiment of a process for layout of a graphical user interface;

FIGS. 5A-B are flow diagrams illustrating, in further detail, aspects of the process of FIG. 4;

FIG. 6 is a flow diagram illustrating a process for determining a GUI container to use for layout of a graphical user interface; and

FIG. 7 is a block diagram of a computing device that may implement embodiments of the technologies described herein.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “pointer” refers to a reference to a target physical or logical memory location, data structure, program instruction, or program segment. A pointer “points to” a target and may be used to locate or obtain the target. A pointer may be implemented in a variety of ways, including an address, an offset, an index, or an identifier.

As used herein, determining a layout of one or more graphical user interface components refers to determining one or more of a dimension of the component or a position of a component. The term “positioning” refers to determining a position. A position may indicate an absolute position relative to a window boundary or a relative position relative to a window or other GUI component. The size of a two-dimensional component includes a horizontal dimension and a vertical dimension. Determining a size refers to determining the horizontal dimension, the vertical dimension, or both. Determining a size may refer to determining a dimension in physical units, such as pixels or inches; it may refer to determining a capacity of a component, such as measured in characters, rows, or other units. Determining a number of characters in a text string or text box is an example of determining a size. Determining a number of rows in a text box is an example of determining a size. Determining a height or width may refer to a determination in physical units or in capacity.

As used herein, the term “GUI element” refers to a graphical user interface object that has a size and position in a graphical user interface form. A GUI element may be visible, though there may be times when a GUI element is hidden. A GUI control is considered to be a GUI element. Text blocks, labels, text boxes, list boxes, lines, and images are examples of GUI elements. In addition to size and position, a GUI element may have other properties, such as a margin, spacing, or the like. As used herein, the term “GUI component” refers to a GUI element, a GUI container, or a group of GUI components.

As used herein, the term “GUI container,” or simply “container,” refers to an object that logically and physically encapsulates one or more GUI components. A GUI container has associated program instructions and specifications that include logic for performing layout of the descendent GUI components.

GUI components may be nested within other GUI components. The GUI components nested within a “parent” GUI component are “descendent” components. A direct descendent is a “child” component. The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

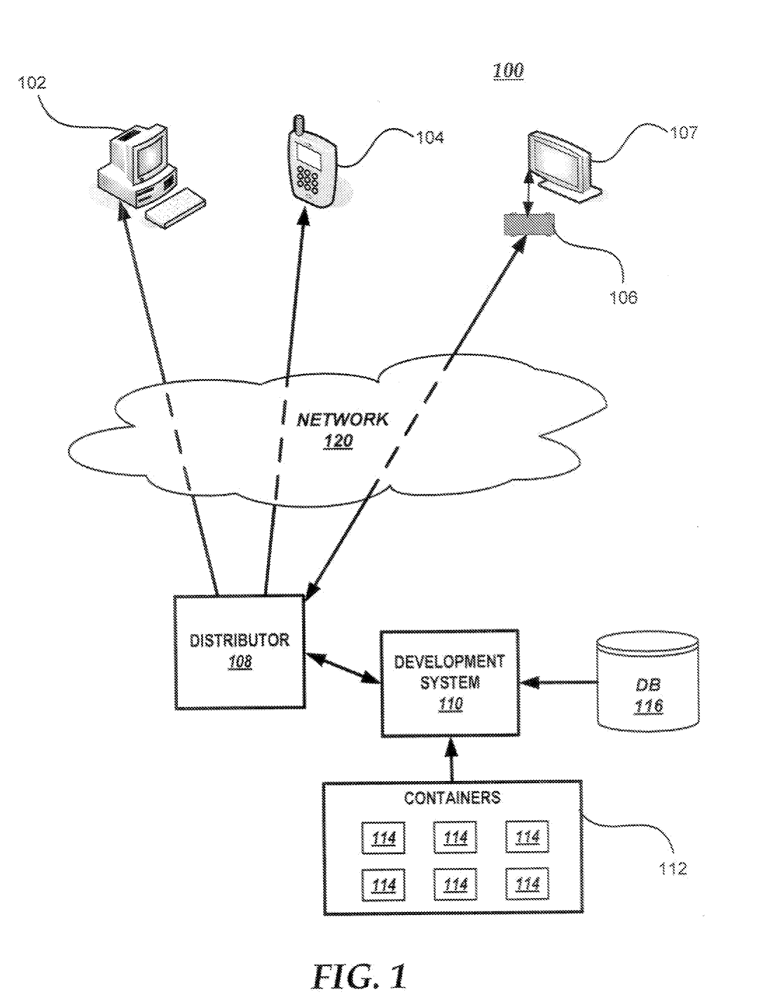

FIG. 1 is a block diagram of an example environment 100 in which embodiments may be practiced. FIG. 1 provides a basic understanding of an example environment, though many configurations may be employed and many details are not illustrated in FIG. 1. As illustrated in FIG. 1, an example environment 100 includes clients 102, 104, and 106. Each of clients 102-106 may be a client computing device, process, or any component that generates a graphical user interface, and is employed by a user to interact with the graphical user interface (GUI). In the example embodiment, client 102 is illustrated as a personal computer, client 104 is illustrated as a mobile communication device, and client 106 is illustrated as a server and associated television monitor 107, in order to show the variety of clients that may exist. Client 106 may be, for example, a media player or game controller. Other computing devices or processes may be clients in various environments. Each client may have one or more associated users that interact with the client.

Example environment 100 includes distributor 108. Distributor 108 may be a computing device, server, or a server farm that includes multiple servers, or a process executing thereon. Distributor 108 may include a Web server, an FTP server, or other type of server. Distributor 108 may be a network file share in a local area network or another type of network. Distributor 108 may store files or other data for installation on one or more of clients 102-106. Distributor 108 may receive a request to install or update an application residing on one of clients 102-106 and, in response, perform actions to facilitate the installation or update, such as downloading files to the client. Distributor 108 may include a Web server or other type of server that provides programs, Web pages, files, or data to clients 102-106.

In the illustrated example environment, distributor 108 communicates with development system 110. Development system 110 may be one or more client computing devices, one or more servers, a process executing thereon, or a combination thereof. Development system 110 may be used by one or more developers to develop application programs, Web pages, scripts, text files, or associated files or data. Text files may include a markup language, HTML, XML, text, or any of various other text formats.

Each of clients 102-106 may communicate with distributor 108 through direct connections or a network 120. Network 120 may include a local area network, a wide area network, a cellular network, or a combination thereof. In one embodiment, network 120 includes the Internet, which is a network of networks. Network 120 may include wired communication mechanisms, wireless communication mechanisms, or a combination thereof. Communications between clients 102-106 and distributor 108, with each other or other computing devices may employ one or more of various wired or wireless communication protocols, such as IP, TCP/IP, UDP, HTTP, SSL, TLS, FTP, SMTP, WAP, Wi-Fi, WiMax, Bluetooth, WLAN, spread spectrum, or digital modulation. In one embodiment, distributor 108 may transfer data or computer programs to any of clients 102-106 on a computer-readable medium, such as a CD-ROM, flash memory, portable disk drive, or other such medium.

As used herein, the term “application” refers to a computer program or a portion thereof, and may include associated data. An application may be an independent program, or it may be designed to provide one or more features to another application. An “add-in” and a “plug-in” are examples of applications that interact with and provides features to a “host” application.

An application is made up of any combination of application components, which may include program instructions, data, text, object code, images or other media, security certificates, scripts, or other software components that may be installed on a computing device to enable the device to perform desired functions. Application components may exist in the form of files, libraries, pages, binary blocks, or streams of data.

Example environment 100 includes database 116, which may store various types of data. In one embodiment, database 116 stores metadata descriptive of GUI elements, and provides at least some metadata to development system 110. Database 116 may also store metadata descriptive of data that is to extracted and used as content with UI elements. For example, a UI element may be a text box, and the corresponding content may be a set of names that are used to populate the text box. The content and use of the metadata is described in further detail herein.

Example environment includes one or more containers 114. The collection of containers is referred to as container collection 112. In one embodiment, each container 114 includes data and program logic that provides specifications and logic to facilitate laying out graphical user interface components. The content and use of containers 114 is described in further detail herein.

FIG. 1 is only an example of a suitable environment and is not intended to suggest any limitation as to the scope of use or functionality of the present invention. Thus, a variety of system configurations may be employed without departing from the scope or spirit of the present invention. For example, any of the functions of distributor 108 may be combined into one or more computing devices, distributed, or replicated among multiple computing devices in a variety of ways. The functions of distributor 108, development system 110, or database 116 may be combined, distributed, or replicated among one or more computing devices.

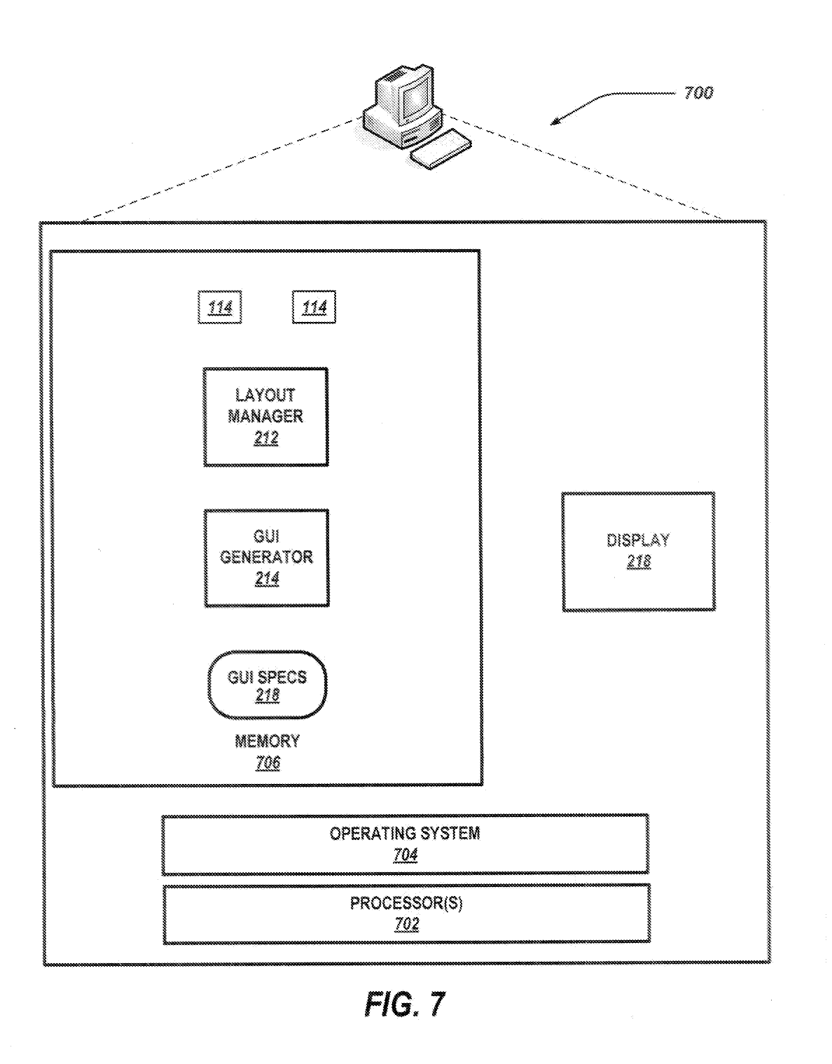

In one embodiment, each of clients 102-106, distributor 108, and development system 110 is implemented by one or more computing devices. A computing device may be a special purpose or general purpose computing device. Example computing devices include mainframes, servers, blade servers, personal computers, portable computers, communication devices, consumer electronics, or the like. FIG. 7 illustrates an example embodiment of a computing device that may be employed.

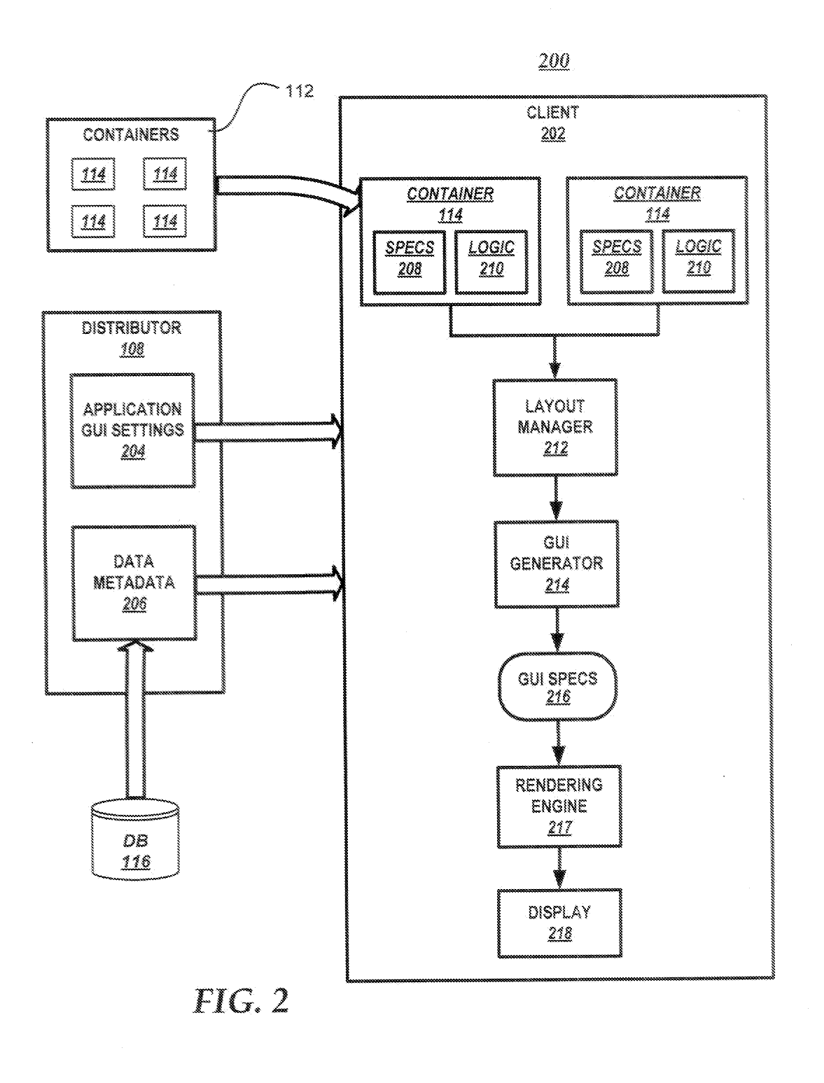

FIG. 2 is a block diagram illustrating an example embodiment of a layout system 200 that may be employed to layout a GUI of an application. In various embodiments, layout system 200 may be implemented with one or more computing devices configured in a variety of ways. Layout system 200 may be employed in environment 100 of FIG. 1, or another environment.

As illustrated, layout system 200 includes distributor 108 and client device 202. Client device 202 may be any of clients 102-106 of FIG. 1, or another client device. In one embodiment, distributor 108 stores application GUI settings 204 and data metadata 206. As indicated in FIG. 2, distributor 108 may transmit application GUI settings 204 and data metadata 206 to client device 202.

In one embodiment, application GUI settings may be specified by a developer using development system 110. Application GUI settings may include one or more of a container identification, a set of GUI components to be displayed with an identified container, an ordering of GUI components, an alignment of GUI components, relationships between GUI components, actions that are to be taken in response to a user selection or manipulation of a GUI component, or other specifications pertaining to a GUI component or container. In one embodiment, application GUI settings includes specifications of relationships among GUI containers and GUI elements that indicate a hierarchical tree structure, in which each GUI component has zero or more child GUI components. A child component of a GUI container may be another GUI container or a GUI element.

Data metadata may include data that describes properties of UI elements or corresponding content to be displayed. This may include one or more of a maximum length or size of a UI element, a minimum size, a desired size, a display name of a UI element, or other data descriptive of a UI element or how it is to be displayed. In one embodiment, data metadata 206, or at least a portion thereof, may be imported from database 116 to development system 110 or distributor 108. In one embodiment, a developer may provide at least a portion of data metadata 206.

Example layout system 200 includes a container collection 112, including one or more containers 114. In one embodiment, each container 114 is selectively sent to client device 202 based on application GUI settings 204. For example, application GUI settings 204 may specify which containers 114 are to be used on a form, and the specified containers may be transferred. In one embodiment, a container collection 112 may be transferred to the client, and the client may extract the containers 114 that are specified by application GUI settings 204. In one embodiment, containers 114 that are already stored on client device 202 may be excluded from the set of containers 114 that are transferred to the client.

Client device 202 may receive and store one or more containers 114. Though two containers 114 are illustrated in client device 202, any number of containers may reside on client device 202. As illustrated in FIG. 2, a container 114 may include specifications 208 and container logic 210. Container logic 210 may be in the form of program instructions, rules, scripts, or other form that represents program logic. Specifications 208 may be represented in any text or binary format, including such formats as XML.

Container logic 210 may include logic to facilitate determining a size, position, format, appearance, or other properties of a GUI component. The logic may facilitate determining a font style or font size, for example. The logic may facilitate determining other properties such as a margin, indentation, or the like. The logic may facilitate determining a positional relationship of two or more GUI components, such as whether they are aligned or offset, or spacing between GUI components. In one embodiment, the logic of a container may specify or determine an alternate container to be employed in a situation in which GUI elements do not fit well in the designated container.

Specifications 208 may specify GUI component properties, such as font styles, default sizes, alignments of GUI components, or the like.

Example layout system 200 includes layout manager 212 and GUI generator 214. In one embodiment, layout system 200 receives one or more containers 114 as input, and employs the container logic 210 and specifications 208 of each container to layout the GUI components of the container. In one embodiment, layout manager 212 includes program instructions to implement at least a portion of the general framework of layout system 200, including managing the container logic of containers 114. In one embodiment, layout manager 212 may include program instructions representing logic that is used to perform generic layout operations, while container logic 210 includes logic that is specific to the respective container. Layout manager 212 may invoke each container 114 to perform actions of the container.

In one embodiment, GUI generator 214 receives an intermediate representation of GUI specifications produced by containers 114 and layout manager 212, and generates GUI specifications 216 in a format for use by a display engine. The format of GUI specifications 216 may be specific to a platform or generic and usable by a variety of platforms. In one embodiment, the GUI specifications 216 is an extensible application markup language (XAML) format employed by Silverlight™, by Microsoft Corporation. However, various other text or binary formats may be employed for GUI specifications 216. In one embodiment, the functions of GUI generator 214, or a portion thereof, may be integrated with containers 114 or layout manager 212, though the functions are illustrated as a system component in FIG. 2.

In one embodiment, rendering engine 217 renders a graphical user interface on one or more displays 218, based on GUI specifications 216. In some embodiments, layout manager 212, containers 114, or GUI generator 214 may receive input specifications descriptive of display 218. These may include properties such as a display size, resolution in dots per inch or other metric, touch screen capabilities, or the like. The components may use these specifications to make layout determinations such as GUI component sizes or spacing between components.

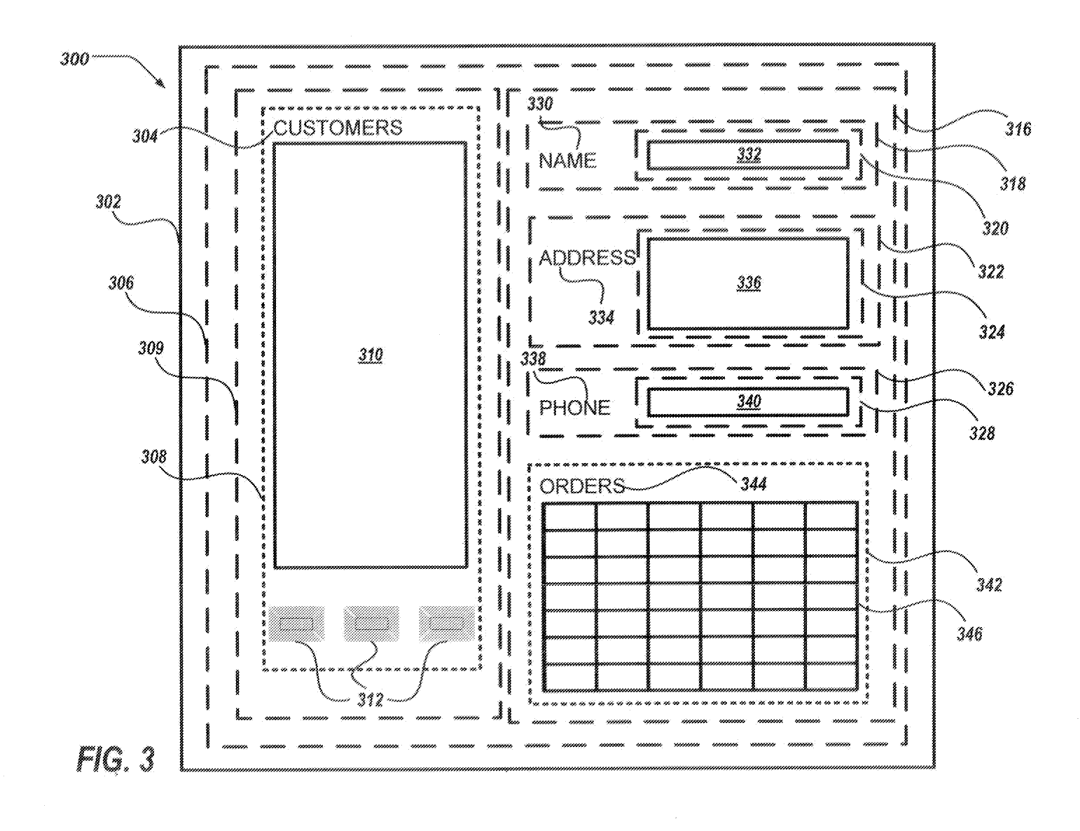

FIG. 3 is a pictorial diagram illustrating an example graphical user interface 300 that may be generated in accordance with at least some of the techniques described herein. FIG. 3 illustrates a number of GUI controls as well as conceptual containers. Graphical user interface 300 is just one example of a graphical user interface that may be generated. Many graphical user interfaces may be generated, and some may differ substantially from others. However, graphical user interface 300 is provided as an example to illustrate some concepts.

Graphical user interface 300 includes form 302. A form is a region of a graphical user interface. It may be an entire window, or a portion thereof. It may be rectangular or any other shape. Parts of a form may be hidden at any point in time, and parts may be visible. In some embodiments, a form corresponds to content in a window. It is to be noted that a form may have a greater area than a window. For example, a scroll bar or panning control mechanism may be used to view portions of a form that has a greater horizontal or vertical dimension than the window within which it is contained. The size of a form is referred to as its virtual size, which may be greater than or equal to the window size.

Example form 302 includes a number of GUI elements. It includes “Customers” label 304, list box 310, buttons 312, “Name” label 330, text box 332, “Address” label 334, text box 336, “Phone” label 338, text box 340, “Orders” label 344, and grid 346. Some of these elements may be grouped and referred to as child elements of a parent control or container. In one embodiment, “Customers” label 304, list box 310, and buttons 312 are child elements of list control 308. List control 308 is represented by a dotted line enclosing its child elements, though the dotted line may not be visible in the GUI. Similarly “Orders” label 344 and grid 346 may be grouped together as child elements of grid control 342.

As illustrated by FIG. 3, one or more GUI components may be included within a container. In one embodiment, a container corresponds to a region of a form. In FIG. 3, dashed lines are used to illustrate a container and its corresponding region. As illustrated, sizing container 320 includes text box 332, and attached label container 318 includes sizing container 320 and “Name” label 330. Similarly sizing container 324 includes text box 336, and attached label container 322 includes sizing container 324 and text box 336; sizing container 328 includes text box 340 and attached label container 326 includes sizing container 328 and “Phone” label 338.

In the illustrated embodiment, vertical stack container 309 includes list control 308; vertical stack container 316 includes attached label containers 318, 322, and 326, and grid control 342. Two-column container 306 includes vertical stack container 309 and vertical stack container 316.

In one embodiment, the containers, controls, and elements, and the relationships between them form a hierarchical tree structure. In the example embodiment, the containers, controls, and elements are represented in a hierarchy as shown in Table 1. In this example, the two-column container is considered to be the topmost, or root, of the hierarchy, which forms a tree structure.

TABLE 1
Example GUI Hierarchy

Two-column container

Vertical stack container

List control (“Customers”)

“Customers” label element
Listbox control
Button controls (3)

Vertical stack container

Attached label element container (“Name”)

“Name” label element
Sizing container (content = text box)

Attached label element container (“Address”)

“Address” label element
Sizing container (content = text box)

Attached label element container (“Phone”)

“Phone” label element
Sizing container (content = text box)

Grid control (“Orders”)

“Orders” label element,
Grid control

In an example embodiment, a process of laying out the graphical user interface represented by FIG. 3may include the following actions. Logic of the two-column container is performed, based on specifications of the two-column container. For example, a specification may indicate that a left column of the two-column container is to be sized at 33% of the width of the container, and the right column is to be sized at 67% of the width. Specifications may include a specification of a margin size on each of the four sides of the two-column container. This logic may determine the constraints of the two child containers of the two-column container.

The logic of each vertical stack container may be employed to determine a size and position based on the size and position of the parent container. Thus, vertical stack container 309 determines its physical size to be the size of the left column of the two-column container 306. Vertical stack container 316 determines its physical size to be the size of the right column of the two-column container 306.

In the example GUI of FIG. 3, list control 308 is a child of vertical stack container 309. It therefore may be designated to have a maximum size and position based on the parent container. In some embodiments, this may be the same size and position as the parent container. In some embodiments, a container may specify a margin, offset, or other specification to apply. For example, a vertical stack container may specify a margin of 10 pixels on the top and bottom, and four pixels on the left and right sides, reducing the constraints of its contents' dimensions accordingly. In some configurations, the size of a child component may be less than the available or maximum size based on its parent. In some embodiments, a component's size may be limited to a specified target size, even though additional space is available for it.

In one embodiment, a list control is a type of control that includes multiple GUI components, which may be containers or other controls. The example list control 308 of FIG. 3 includes “Customer” label 304, list box 310, and buttons 312. These elements may be sized and positioned based on the respective specifications of minimum and target size of each element, within the constraints of the size and position of the parent list control 308.

As discussed herein, vertical stack container 316 includes three attached label containers and a grid control. Logic of the vertical stack container 316 may determine a horizontal or vertical size for each of these child objects, as well as a position of each object. These determinations may be based on specifications of the vertical stack container, including application GUI settings 204, of FIG. 2. For example, one such setting may indicate whether the child objects are to be left aligned with each other, centered, right aligned, or other positional specifications. In one embodiment, size or position may be based on metadata corresponding to each child object. For example, metadata may indicate a relative importance of each attached label object or respective child or descendent controls. Logic of the vertical stack container 316 may perform a comparison of an importance measure of multiple label objects or their descendent GUI elements and determine an ordering based on this, as well as an alignment. One such alignment may include an indentation based on the relative importance.

Vertical stack container 316 may include logic to determine a position of child objects based on their content type. For example, a grid may be scrollable, allowing for variation in size. Therefore, logic of the vertical stack container 316 may determine a grid to be placed below other peer objects for which scrolling is not a property. As indicated in example GUI 300, grid control 342 may be positioned below attached label containers 318, 322, and 326 based on this property.

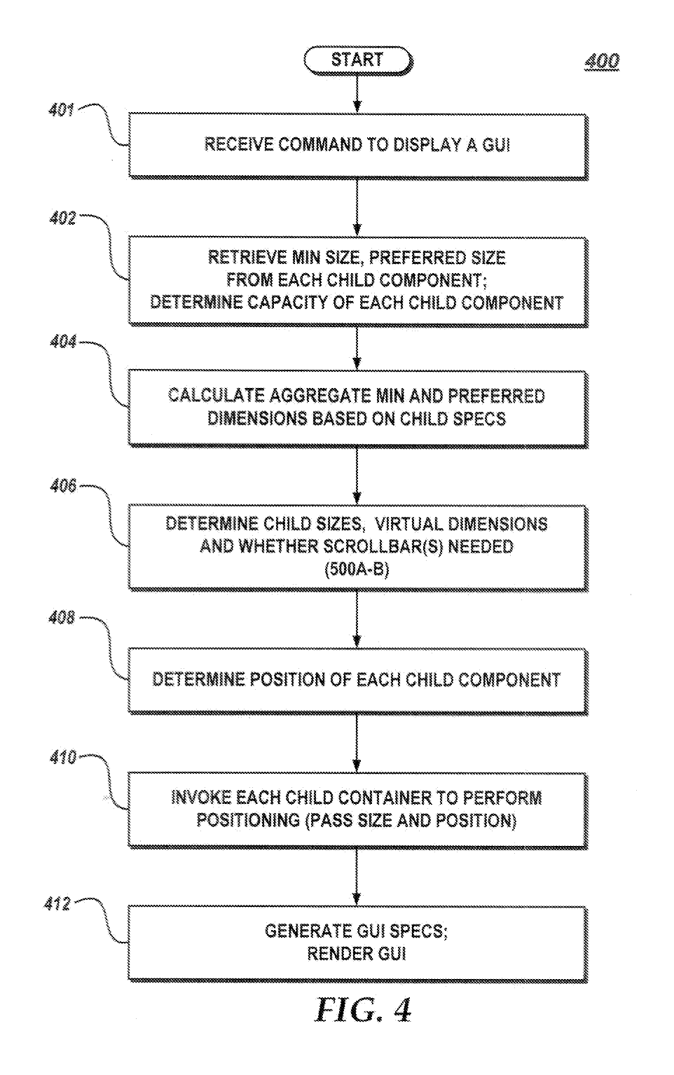

FIG. 4 is a flow diagram illustrating an example embodiment of a process 400 for laying out a graphical user interface. In one embodiment, at least a portion of the actions of process 400 are performed by client device 202 of FIG. 2. In one embodiment, process 400 or a variation thereof may be performed with respect to each container of a GUI beginning with the topmost, or root container. In the discussion that follows, the “current container” refers to a container corresponding to the current iteration of process 400.

The illustrated portions of process 400 may be initiated, after a start block, at block 401, where a command to display a graphical user interface is received at the client. This command may be a direct or indirect result of a user action, such as manipulating a GUI control, entering a text or voice command, initiating execution of a program, or other input. The command may be a result of an application or system action, such as a system notification of an event or status, or the like.

Process 400 may flow to block 402, where a specified minimum size and target size of each of child components may be retrieved. This may be performed by the current container 114 or the layout manager 212, communicating with each child component and requesting its size, or retrieving a specification of the child component's size. A child component may be a container or a control. This action may include a recursive descent of the component's child components. In one embodiment, each component may have specifications of a minimum size and a target size. The target size may specify a desirable size of the component if there is enough space. The minimum size and target size may be specified by a developer, by default values, or in another manner. The minimum size and target size may be included in the application GUI settings 204 or the container specifications 208. Minimum size and target size may also be included in data metadata 206 or determined from data metadata. For example, metadata associated with a GUI element may indicate a maximum number of characters in the corresponding data field or a maximum number of rows. The actions of block 402 may include determining a capacity of a text string based on the metadata. In one embodiment, a sizing container, such as sizing containers 320, 324, or 328 may include a text box, and determine the capacity of the text box in characters based on the corresponding metadata. This may include determining a width capacity or a row capacity. As another example, a minimum width of a text label may be a measure of the number of characters in the label.

Upon retrieving a minimum size and target size of each child component, process 400 may flow to block 404, where the current container may calculate aggregate dimensions of its child components, based on the retrieved specifications. The aggregate dimensions may also be based on a relative configuration of the child components with respect to each other, according to the logic of the current container. The vertical dimension is also referred to herein as height. An aggregate minimum height may be determined by adding the minimum height of each child component that is vertically layered. It is to be noted that components may be considered to be layered in a dimension even though there is an overlap between them in that dimension. A determination of whether two or more child components are vertically layered may be based on container specifications 208 (FIG. 2), container logic, application GUI settings 204, data metadata 206, or other specifications.

In a configuration having a group of two or more child components that are vertically aligned, a determination of an aggregate minimum height may determine the greatest minimum height of the group components as the minimum height of the group.

In another example, a vertical stack container, in which each child component is stacked in a vertical column, may determine an aggregate minimum height of the child components by calculating a sum of the minimum height of each child component; it may determine a aggregate minimum width of the child components as the greatest minimum width of the child components. Similarly, a horizontal stack container may determine an aggregate height as the greatest child component height, and the aggregate width as the sum of its child component widths. In another example, a two-column container may include a specification of a ratio between the widths of its columns, and determine an aggregate accordingly. For example, a two-column container that is configured such that the left column is one-third of the right column in width may determine an aggregate width based on the widths of each child component combined with this restriction. More specifically, it may determine an aggregate width of the left column and an aggregate width of the right column, and increase one of the aggregate widths so that the left column has a width of half of the right column. Determinations of an aggregate height or width may also include allowance of configured margins, spaces between components, or other specifications.

The GUI components of FIG. 3 illustrate the determination of an aggregate minimum height. Vertical stack container 316 includes three attached label containers 318, 322, and 326, and grid control 342. Together, these components make up a group of vertically layered components. Therefore, an aggregate minimum height may include a sum of the height of each of these components. Attached label container 318 includes child “Name” label 330 and child sizing container 320, both of which are vertically aligned. Therefore, an aggregate minimum height of the attached label container may include the greater height of these two child components. As another example, two-column container 306 may determine an aggregate minimum height by determining the greater minimum vertical height of its two child components, vertical stack container 309 and vertical stack container 316. Determination of an aggregate target height may proceed as described above for aggregate minimum height, except the target heights of child components are used.

Determination of a minimum width and a target width may be performed in a manner similar to that described for determining a minimum height, though in a horizontal direction.

Determination of a minimum or target size in either dimension may include determining a dimension of a child control. This may be based on a specification of the child control or on data metadata 206 (FIG. 2). For example, metadata of “Name” label 330 may indicate a minimum width and height of the label. Metadata of text box 336 may indicate a minimum width and height of the text box. The actions of block 404 may include recursively invoking child containers to retrieve their minimum and target sizes.

The process may flow to block 406, where the current container may determine a size of each child component, the resulting virtual dimensions of the container, and whether a horizontal scroll bar, a vertical scroll bar, or no scroll bars are to be used. A virtual dimension of a container may exceed the physical dimension of the container in a configuration in which a scroll bar is used. For example, a virtual height of a container may be greater than the physical height, though only an amount equal to the physical height may be visible at a single time. A user may employ a scroll bar to view various sections of the container.

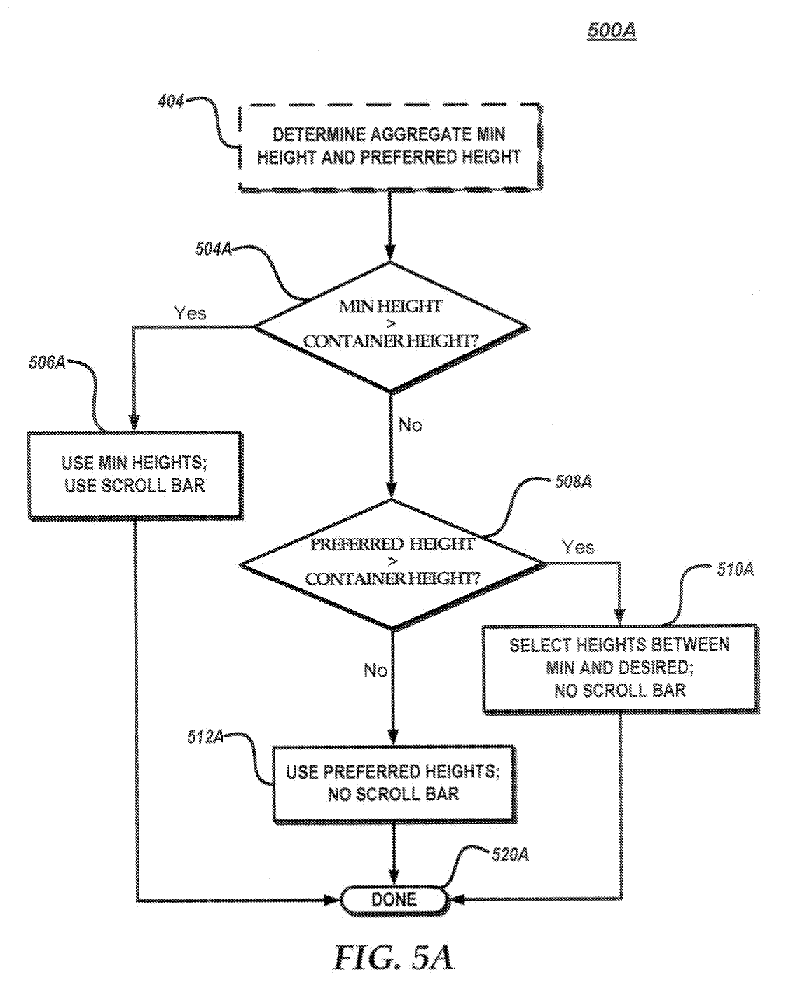

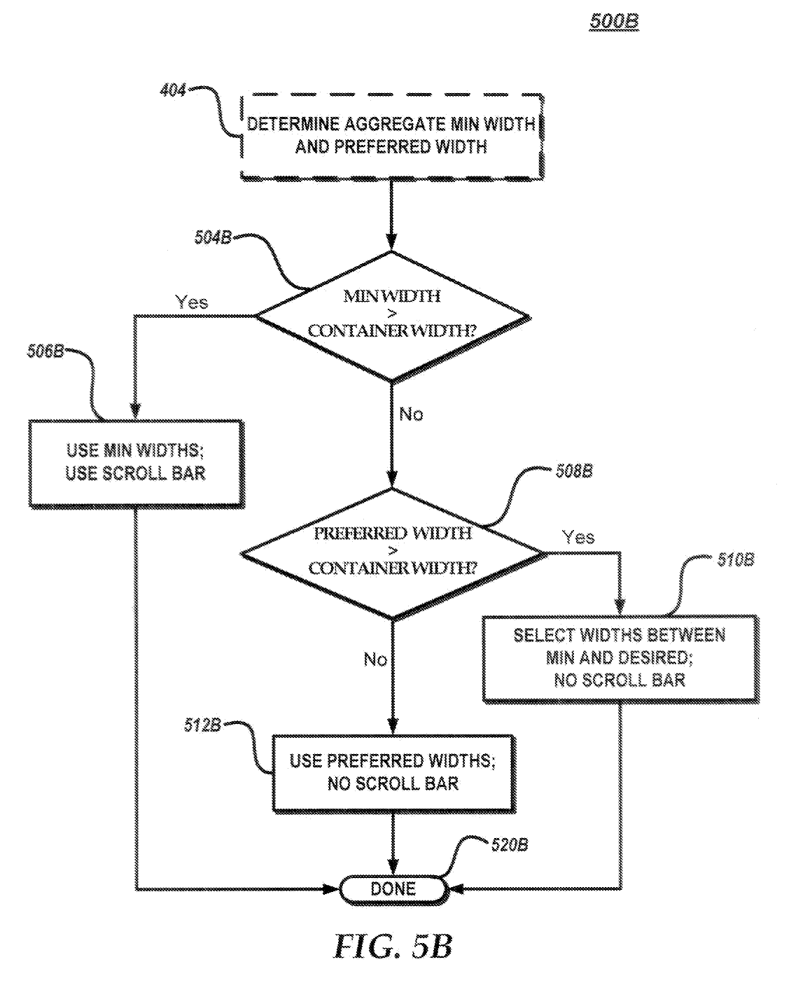

FIGS. 5A-B illustrate the actions of an embodiment of block 406 in further detail. Briefly, in one embodiment, if the aggregate target size in either dimension exceeds the container's physical size, a scroll bar is used in that dimension.

The process may flow to block 408, where a position of each child component may be determined, based on the child component sizes and the virtual size of the current container. This determination may also be based on specifications such as margins, distances between components, or logic of the current container.

The process may flow to block 410, where each child container is invoked to perform actions to refine its size or position. This may be based on specifications of the child container, specifications of sibling containers, or logic of the child containers. Examples of such logic are provided herein. In one embodiment, when invoking each child container, the child container size or position may be passed. In one embodiment, a child container may employ an alternate or complimentary technique for retrieving its size or location.

The process may flow to block 412, where GUI specifications may be generated, reflecting the various determinations of size and position. As discussed herein, the GUI specifications may be embodied in any of a variety of text or binary formats. In one embodiment, the GUI specifications are generated in an XMAL format employed by Silverlight™. The actions of block 414 may include rendering the GUI from the generated GUI specifications. In one embodiment, a GUI may be rendered without a separate step of generating GUI specifications. The GUI may be rendered, for example, on display 218 of FIG. 2.

FIG. 5A illustrates an embodiment of a process 500A for determining sizes of child GUI components, dimensions of a container, and whether a scrollbar is to be used, with respect to a vertical dimension. Process 500A may be performed as at least a portion of the actions of block 406 in FIG. 4. In one embodiment, at least a portion of process 500A or a variation thereof may be performed by layout manager 212, container logic 210, or a combination thereof.

FIG. 5A includes block 404, of FIG. 4, in dashed lines, for context. As discussed herein, block 404 may include determining an aggregate minimum height and aggregate target height of the current container. The process may flow to decision block 504A, where a determination is made of whether the aggregate minimum height is greater than the container height. The container height indicates the physical height of the container. In a configuration with an aggregate minimum height greater than the container height, the process may flow to block 506A, where a determination is made that each of the child components are to have a height equal to their respective minimum height, and that a scroll bar is to be used in the container, to facilitate viewing a container with a virtual height greater than the physical height. The process may then flow to a done block 520A, and exit or return to a calling program.

If, at decision block 504A, it is determined that the aggregate minimum height is not greater than the container height, the process may flow to decision block 508A, where a determination is made of whether the aggregate target height is greater than the current container height. If the determination is positive, the process may flow to block 510A. The actions of block 510A may include determining to not use a vertical scroll bar in the current container. The actions may also include determining a height for each child component between its minimum height and target height such that the aggregate height is not greater than the height of the current container. This allows the virtual height to be equal to the physical container height, so that a scroll bar is not needed. The determination of the height of each component may be based on the logic of the current container, specifications, or configuration data. For example, in one configuration, one or more child components may have a priority in receiving a portion of the amount between the aggregate minimum height and the container's physical height. In one configuration, the amount may be distributed among the child components equally or in another proportion. The process may flow from block 510A to done block 520A, and exit or return to a calling program.

If, at decision block 508A, it is determined that the target height is less than or equal to the container height, the process may flow to block 512A, where a determination is made to use the target height of each child component. At this block, the virtual height of the container is determined to be equal to the physical height. Therefore, it may be determined to not use a vertical scroll bar with the current container. An extra amount between the aggregate target height and the container height may be used by distributing the child components, inserting a larger top or bottom margin, or in another manner based on configured logic or settings.

FIG. 5B illustrates an embodiment of a process 500B for determining sizes of child GUI components, dimensions of a container, and whether a scrollbar is to be used, with respect to a horizontal dimension, referred to herein as width. Process 500B may be performed as at least a portion of the actions of block 406 in FIG. 4. Process 500B may be similar to process 500A, though applying to width, rather than height. The discussion of process 500A is therefore applicable to process 500B, with this difference. Processes 500A and 500B may be performed concurrently or sequentially for a container.

Briefly, at decision block 504B, a determination is made of whether the aggregate minimum width is greater than the container width. If it is, at block 506B, the minimum child component widths are used and a horizontal scroll bar is employed. If not, at decision block 508B a determination is made of whether the aggregate target width is greater than the container width. If it is, at block 510B, a width of each child component is determined that is between the component's minimum width and the desired width; a horizontal scroll bar is not used. If the aggregate target width is not greater than the container width, at block 512A the child component target widths are used; a horizontal scroll bar is not used. At done block 520B, the process may exit or return to a calling program.

It is to be noted that a horizontal scroll bar is a UI element, and may affect the determinations of process 500A. Similarly, a vertical scroll bar is a UI element, and may affect the determinations of process 500B. In one embodiment, a determination to use a horizontal or vertical scroll bar may result in a second iteration of the complimentary process 500A or 500B, or a portion thereof.

In one embodiment, a container may include logic to determine its size or position in one or two dimensions. For example, a parent container may determine a maximum size of a child container, and the child container may determine its size or position within the area specified by the parent container.

An attached label container is one example of this type of logic, in one embodiment. An attached label container may include a label element and a content control. Attached label containers 318, 322, and 326 are examples of this. Each of these attached label containers includes a text label and a text box. In one embodiment, an attached label container may include logic to determine a size of its control based on a size of one or more sibling controls. It may determine a horizontal or vertical position of its control or label based on the position of a control or label in another attached label container. For example, in one embodiment, each of the group of attached label containers 318, 322, and 326 may include logic or specifications to set the horizontal size of its corresponding text box to have the same width, or at least approximately equal width, as the text boxes of the others of the group. This may be, for example, the greatest width of the three controls as specified by the data metadata. Similarly, each of the attached label containers 318, 322, and 326 may determine to align itself with the others of the group, so that each label is aligned with the other labels, or each text box is aligned with the other text boxes of the group. The alignments of labels or text boxes may be left aligned, right aligned, or both. In the example GUI 300, the labels 330, 334, and 338 are left aligned; the text boxes 332, 336, and 340 are both left and right aligned. In one embodiment, an attached label container may determine to horizontally align itself with a sibling attached label container if the two containers are already closely aligned to each other.

Containers may include logic to determine other layout characteristics, such as an ordering of containers, indentation, or formatting characteristics. For example, sibling components may have respective properties indicating a level of importance of each component. Logic may include a determination of an ordering of sibling components based on their respective importance levels. For example, attached label containers 318, 322, and 326 may each have respective metadata indicating that “Name” attached label container 318 is the most important, “Address” attached label container 322 is next in importance, and “Phone” attached label container 326 is third in importance. Layout logic may position each of these attached label containers in an order reflecting their relative importance. Each component may be indented at a level that increases as its importance decreases. Font sizes or other formatting characteristics may be determined for text within a component based on an importance level or other property of the component. In one embodiment, this logic and program instructions may be included in the logic of each sibling container. In one embodiment, a parent container includes the logic and program instructions to determine the ordering, indentation, or formatting of its child containers, based on an importance level or other properties.

In one embodiment, a container may determine its size within constraints specified by a parent container. For example, vertical stack container 316 may determine a width of each of the attached label containers 318, 322, and 326. The attached label containers may determine that they are to have the same width, and adjust the width of each one to be less than or equal to the width determined by the parent vertical stack container. Each attached label container may determine its indentation and width within the maximum size constraint determined by the parent container.

One embodiment includes a tab container. A tab container includes logic for laying out GUI elements in a tab form corresponding to a tab label. Applications, such as browsers, may display one or more tab labels, each tab label having a corresponding tab form. Typically, one tab form of a window is displayed at a time. In response to a user selection of a tab label, the corresponding tab form is displayed. A GUI layout system may include one or more tab containers.

In one embodiment, a tab container includes logic to determine a size of the corresponding tab form based on the size of each other tab container, as well as GUI elements within the tab container. It may determine the height and width of its corresponding tab form to be at least as great as each other tab container in the corresponding dimension. For example, in a configuration with preliminary determinations of tab containers to be 500×100, 300×400, and 200×200, each tab container may determine its dimensions to be 500×400, based on the greatest width of 500 and greatest height of 400.

In one embodiment, a container may determine to use an alternate container, based on the virtual size as determined by the container and the available physical container size. For example, a container may include two or more child containers such that a minimum virtual size does not display well in the current environment. The container may determine to use two or more tab containers to display the child containers. In another example, a container may determine, based on its minimum virtual size, to display one or more of its GUI components in a pop-up window, in order to obtain a more desirable graphical user interface. In one embodiment, if a first container determines that a second container is to be employed, and the second container is not on the client device, the second container may be retrieved and employed.

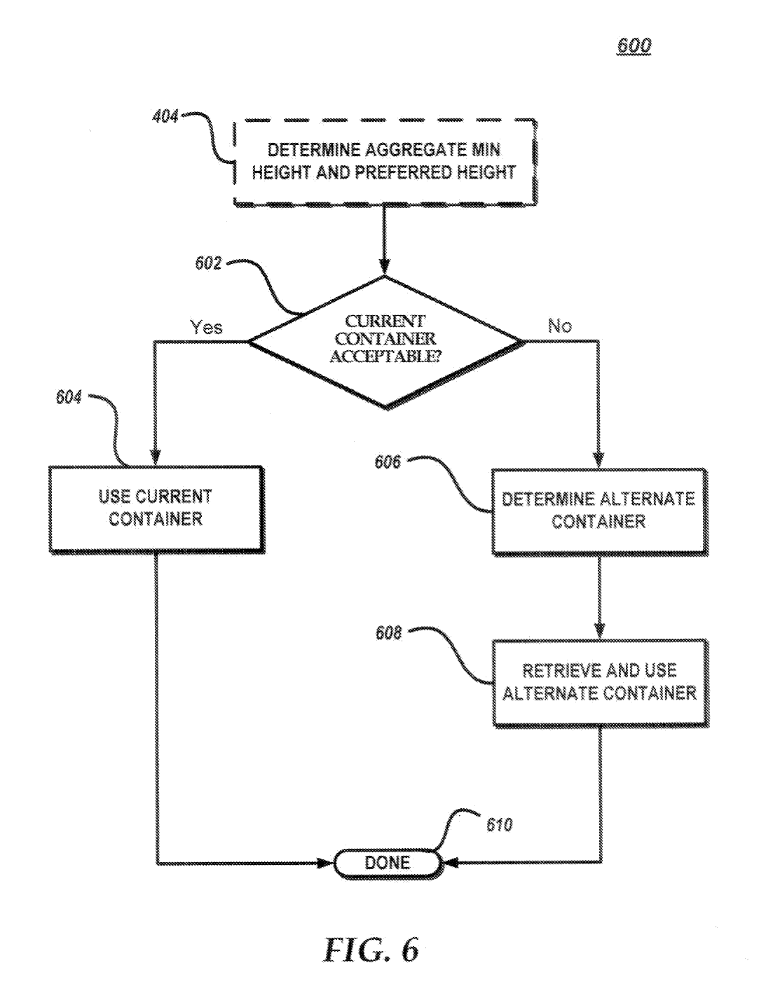

FIG. 6 illustrates an embodiment of a process 600 for determining a GUI container to use. Process 600 may be performed in conjunction with process 500A, 500B, or a portion thereof. In one embodiment, at least a portion of process 600 or a variation thereof may be performed by layout manager 212, container logic 210, or a combination thereof.

FIG. 6 includes block 404, of FIG. 4, in dashed lines, for context. As discussed herein, block 404 may include determining an aggregate minimum height and target height of the current container. The process may flow to decision block 602, where a determination is made of whether the current container is acceptable, based on the minimum height or width of the current container. This determination may be based on the physical size of the current container, metadata corresponding to GUI elements within the current container, or other data.

If it is determined that the current container is acceptable, the process may flow to block 604, where the current container is used, such as by the techniques described herein. The process may flow to done block 610 and exit or return to a calling program.

If, at decision block 602, it is determined that the current container is not acceptable, the process may flow to block 606, where a determination is made of an alternate container to use. This may be based on configured settings, container logic, or other data or logic. The process may flow to block 608, where the determined alternate container is retrieved and used in place of the current container. In some configurations, retrieval may include retrieval from distributor 108 (FIG. 2) or another remote device. The process may flow to done block 610 and exit or return to a calling program.

FIG. 7 shows one embodiment of a computing device 700, illustrating selected components of a client device that may be used to perform functions described herein and attributed to any of clients 202, or 102-106. Computing device 700 may include many more components than those shown, or may include less than all of those illustrated.

As illustrated, computing device 700 includes one or more processors 702, which perform actions to execute instructions of various computer programs. In one configuration, each processor 702 may include one or more central processing units, one or more processor cores, one or more ASICs, cache memory, or other hardware processing components and related program logic. As illustrated, computing device 700 includes an operating system 704. Operating system 704 may be a general purpose or special purpose operating system. The Windows® family of operating systems, by Microsoft Corporation, of Redmond, Wash., are examples of operating systems that may execute on computing device 700.

Memory 706 may include one or more of a variety of types of computer storage media, including volatile or non-volatile memory, RAM, ROM, solid-state memory, disk drives, optical storage, or any other medium that can be used to store digital information. In one configuration, memory 706 may store layout manager 212, GUI generator 214, and GUI specifications 216. In some configurations, any one or more of these components, or a portion thereof, may be implemented in hardware, software, or a combination thereof.

Computing device 700 may include display 218. Display 218 may be integrated with computing device 700, such as in a laptop computer or cell phone. Display 218 may be separate from computing device 700 and communicate with computing device directly or indirectly via wired or wireless technology.

Though not illustrated in FIG. 7, computing device 700 may include a video display adapter, basic input/output system (BIOS), and associated components. Computing device 700 may also include a network interface unit (not shown) for communicating with a network, such as network 120 of FIG. 1. Embodiments of computing device 700 may include one or more of a keyboard, pointing device, audio component, or microphone.

It will be understood that each block of the flowchart illustrations of FIGS. 4, 5A-B, and 6, and combinations of blocks in the flowchart illustrations, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. At a client computing device having an associated display, a computer-based method of laying out a plurality of graphical user interface (GUI) elements at the client computing device, comprising, in response to a command to display a graphical user interface form, performing actions including:
a) receiving a set of metadata descriptive of a plurality of controls to be included in the graphical user interface form;
b) receiving a set of graphical user interface settings;
c) receiving a set of containers, each container having associated program instructions and specifications, the containers and the plurality of controls forming a hierarchical structure;
d) determining a capacity of at least one control of the plurality of controls based on the set of metadata;
e) determining a size and a position of the plurality of controls based on the set of metadata, the set of containers, and the display environment; and
f) generating a specification of the graphical user interface form based on the determined size or position.

2. The computer-based method of claim 1, further comprising executing the program instructions of each container to determine a minimum size and a target size of each container; and determining a virtual size of each container based on the container's corresponding minimum size and target size.

3. The computer-based method of claim 1, the set of containers and the plurality of GUI elements forming a hierarchical structure, the computer based method further comprising determining, for each container, a virtual size of the plurality of GUI elements that are descendents of the container in the hierarchical structure, based on the set of metadata.

4. The computer-based method of claim 1, the set of containers and the plurality of GUI elements forming a hierarchical structure, the computer based method further comprising determining, for each container, whether to include a scroll bar based on an aggregate minimum size and an aggregate target size of GUI elements, of the plurality of GUI elements that are descendents of the container in the hierarchical structure.

5. The computer-based method of claim 1, the set of containers including a plurality of different types of containers, each different type of container including respective logic for determining a size or position of GUI elements, of the plurality of GUI elements that are associated with the container.

6. The computer-based method of claim 1, the set of containers including a first container and a second container, the actions further include executing program instructions corresponding to the first container to determine an ordering of the first container relative to the second container based on the metadata.

7. The computer-based method of claim 1, the set of containers including a first container and a second container, the actions further include executing program instructions corresponding to the first container to determine an indentation of GUI elements associated with the first container based on a relationship between a first GUI element associated with the first container and a second GUI element associated with the second container.

8. The computer-based method of claim 1, the set of containers include a first tab container and a second tab container, the actions further including determining a dimension of the first tab container based on a corresponding dimension of the second tab container.

9. The computer-based method of claim 1, the actions further including selectively employing a second container based on a size of a first container and its graphical user interface elements.

10. A computer-based system for laying out a plurality of graphical user interface elements in response to a command to display the plurality of graphical user interface elements, the system comprising:
a) a set of GUI containers, each container including respective program instructions and specifications;
b) an input mechanism for receiving metadata descriptive of the plurality of graphical user interface elements; and
c) a layout manager that invokes the program instructions corresponding to each container;
the program instructions corresponding to each container executable by a processor to perform actions, including:
i) determining an aggregate minimum height and an aggregate target height of a plurality of child components of the container;
ii) determining a height of at least one GUI element based on the aggregate minimum height and the aggregate target height;
iii) determining a capacity of at least one GUI element based on the metadata;
iv) determining a position of the at least one GUI element based on a comparison of the at least one GUI element with at least one other GUI;
v) aligning a first GUI element with a second GUI element; and
vi) determining whether to employ a vertical scroll bar based on the aggregate minimum height.

11. The computer-based system of claim 10, the program instructions corresponding to at least one container of the set of GUI containers executable by a processor to perform additional actions, including determining at least one of a size, width, height, or indentation based on properties of other GUI containers of the set of GUI containers.

12. The computer-based system of claim 10, determining the height of the at least one GUI element comprising if the aggregate minimum height is less than a height of the container and the aggregate target height is greater than the height of the container, determining the height of the at least one GUI element to be an amount greater than a minimum height of the at least one GUI element and less than a target height of the at least one GUI element.

13. The computer-based system of claim 10, further comprising means for determining a width of a first UI element based on a width of a second UI element that is vertically layered above or below the first UI element.

14. The computer-based system of claim 10, the layout manager including means for traversing a hierarchy of the GUI containers representing a graphical user interface.

15. The computer-based system of claim 10, further comprising a GUI generator that generates GUI specifications in a markup language format for use by a display engine.

16. A computer-based system for laying out a plurality of graphical user interface elements in response to a command to display the plurality of graphical user interface elements, the system comprising:
a) a set of containers, each container comprising specifications and program instructions for laying out a set of GUI elements that are descendent GUI elements of the container by performing actions including:
i) determining an aggregate minimum size of descendent GUI components of the container, the descendent GUI components including the descendent GUI elements;
ii) determining an aggregate target size of the descendent GUI components;
iii) determining a virtual size of the container based on the aggregate minimum size and the target size; and
iv) selectively inserting at least one scroll bar based on the virtual size of the container;
b) a layout manager that manages execution of the program instructions of each container; and
c) a processor for execution of the program instructions of each container.

17. The computer-based system of claim 16, further comprising means for determining a position of a first GUI element based on a comparison of the first GUI element with a second GUI element.

18. The computer-based system of claim 16, further comprising means for determining a dimension of a first GUI element to be at least approximately equal to a corresponding dimension of a second GUI element.

19. The computer-based system of claim 16, further comprising means for determining a container type based on the determined aggregate minimum size.

20. The computer-based system of claim 16, further comprising means for determining a capacity of a GUI element based on metadata associated with the GUI element.
